(19) United States
(12) Patent Application Publication
(10) Pub. No.: US 2024/0177201 A1
(43) Pub. Date: May 30, 2024

(54) Systems and methods to protect business bathrooms from vandalism and destruction of properties and for bathroom users to find clean and well-maintained public/private bathrooms

(71) Applicant: Rodante Garcia, Roseville, CA (US)

(72) Inventor: Rodante Garcia, Roseville, CA (US)

(21) Appl. No.: 17/993,907

(22) Filed: Nov. 24, 2022

(51) Int. Cl. G06Q 30/0282; G06Q 30/01; G06Q 30/0283

(52) U.S. Cl. CPC G06Q 30/0282; G06Q 30/01; G06Q 30/0283

(57) ABSTRACT

This disclosure relates generally to a systematic method of finding public or private bathrooms and providing feedback and rating once the services are provided. More specifically, the present invention relates to systems that enable users to send feedback through an app or website and also view the overall feedbacks on interaction of a particular bathroom facility. The system also provides protection to business owners using flagging system. The business owners can sell other products and services in addition to bathroom services once they are registered at the platform.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

The present invention relates generally to online information system. More specifically, the invention is directed toward an online system enabled as a community service allowing business owners to protect their business bathrooms from vandalism and destruction of properties and to help people find nearby clean and well-maintained bathrooms and also provide listing services of bathrooms.

### DESCRIPTION OF THE RELATED ART

Surviving a pandemic has a way of forcing people to focus on the basics: health, food, shelter, the need for human connection—and going to the bathroom.

This became evident during the Great Toilet Paper Shortage of 2020, when panic buyers emptied store shelves in the first weeks of U.S. stay-home orders. As Covid closures continued, the pandemic revealed a different toilet-related problem that predated the novel coronavirus: a dire lack of public restrooms. Though facilities in bars and retail establishments are often thought of as “public,” widespread shutdowns served as a stark reminder that they're really not—and that few genuinely public bathrooms remain in American cities.

That reality was underscored as the pandemic dragged on. Infection fears led cities to padlock the few public restrooms that were available. Stories emerged about Amazon and Uber drivers resorting to peeing in bottles, while unhoused individuals relied on adult diapers or five-gallon buckets filled with kitty litter. Public urination complaints spiked in cities like New York and Washington, D.C., especially when crowds flooded the streets in the summer of 2020 to protest the murder of George Floyd.

“The state of public restrooms in the U.S. is pretty deplorable, with certain exceptions,” says Steven Soifer, president and co-founder of the American Restroom Association. “Public restrooms are a half-assed job. This is a public health concern, especially with Covid. It's been a mess.”

The lack of public restrooms in the U.S. hasn't gone unnoticed. In 2011, a United Nations-appointed special rapporteur who was sent to the U.S. to assess the “human right of clean drinking water and sanitation” was shocked by the lack of public toilets in one of the richest economies in the world. A full accounting of truly public facilities is elusive, says Soifer, but government-funded options are exceedingly rare in the U.S., compared to Europe and Asia; privately owned restrooms in cafes and fast-food outlets are the most common alternatives. According to a “Public Toilet Index” released in August 2021 by the U.K. bathroom supply company QS Supplies and the online toilet-finding tool PeePlace, the U.S. has only eight toilets per 100,000 people overall—tied with Botswana.

The presence or absence of restrooms in public spaces has long been an indication of a particular group's place in society. From women to people of color to those with disabilities, vulnerable communities have struggled to have this most fundamental of needs accommodated.

The prior art has not only had problems in providing restrooms facilities to general public but the previous systems also generally failed to provide an efficient and functional method to provide restrooms availability information using web-based technology.

The current application has the novel feature of providing available bathrooms in nearby vicinity to the user by facilitating the user through web portal and mobile application. The user can also add their bathrooms and can get started with their business from comfort of their home.

Thus it has been noted, to Applicant's knowledge, none of these prior art methods is entirely suitable to meet these needs and is cumbersome. Therefore, there is a need in the prior art in which the inconveniences, as mentioned earlier, difficulties, and grooming problems are eliminated for all practical purposes. Thus, the present invention provides such a method, and the overall combination of these features is nowhere disclosed in the prior art cited above, which appears to represent the general art in this area, although it is not intended to be an all-inclusive listing of pertinent prior art patents.

### SUMMARY

In light of the disadvantages of the prior art, the following summary is provided to facilitate an understanding of some of the innovative features unique to the present invention and is not intended to be a complete description. A full appreciation of the various aspects of the invention can be gained by taking the entire specification, claims, drawings, and abstract as a whole.

The present subject matter relates generally to a system for providing an online platform allowing general public to find and avail bathroom facility in their nearby vicinity. More specifically, the present invention relates to systems that enable users to login on a platform through an app or website and also view the bathrooms facility in their nearby area and facilities available and their respective ratings.

The invention is a software app and a website accessible through mobile and computing devices that allows community member to share their bathrooms for public and post charges. The user would be able to able to rate the bathroom facility and can leave the feedback.

Another embodiment of the invention is that is to provide a close community application where a flagging system is proposed to control vandalism. The flagging system is composed of 4 flags. Yellow flag, red flag orange flag and clear flag. The yellow flag is when a business owner suspects a number of people in a number of hours' time frame where the vandal was committed.

Another embodiment of the invention is that the red flag allows business owner identify the vandal and red flags the vandal in the entire system where some business owners will also see red flag users and now has the option to be vigilant or just refused the use of the bathroom for this user. The red flag user can always dispute the claim of the business owner hence red flag turns into an orange flag. Meaning the customer has disputed the allegation until the disputes and allegations are settled between 2 parties. The business owner and the customer. If the customer realized that he is at fault then he can always settle, once he settled then his flag turns into the clear flag. On the other hand, if the business owner was at fault, he can manually clear flag the customer in Tsekmo app.

It is accordingly an object of the invention to provide a dedicated web and client application for gathering feedback on the services in a certain community. The web-based application is empowered through a GUI consumer-based interface and the feedback is stored and sorted through a database server at the backhand.

Another novel feature of the invention is based on an online system and business owner create an account under Tsekmo App/website and will upload pictures of the bathroom, and will give their available schedule in days hours, and minutes. Further, while providing a unique sale of products and services of items, the invention overcomes the disadvantages of the heretofore-known devices and methods of this general type and that consumes a minimum of computer and desktop resources and allows a user to passively browse through the application and give their feedback through a computing device of their choice in their own time.

Although the invention is illustrated and described herein as embodied in as an online system which is accessible through web and computer client application, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

Other objects, features and advantages of the present invention will be apparent from the accompanying drawing and from the detailed description which follows.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, FIGURES, and Claims.

### BRIEF DESCRIPTION OF DRAWINGS

The accompanying FIGURES, where like reference numerals refer to identical or functionally similar elements throughout the separate views, together with the detailed description below, are incorporated in and form part of the specification and serve to further illustrate embodiments of concepts that include the claimed invention, and explain various principles and advantages of those embodiments.

FIG. 1 shows a table the business owner chose to make use of his bathroom for free for the first 5 minutes then $1 per minute for the next 6-10 minutes then 11-20 minutes, or till done is $2 per minute.

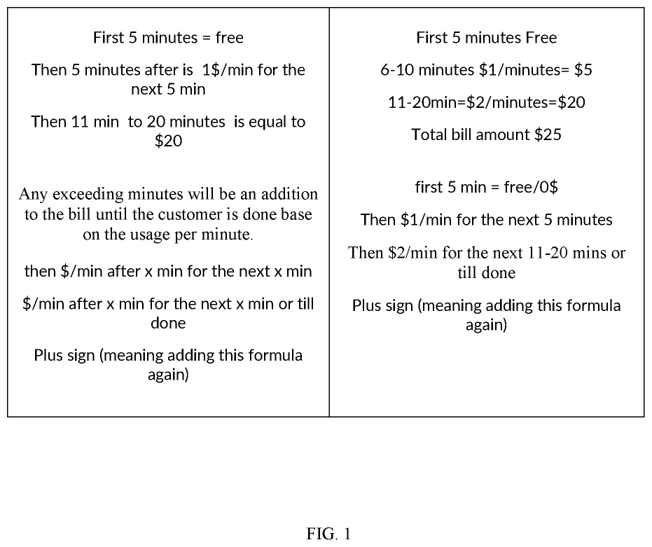

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

In our perilous times, there are many incidents where bathroom users are using the bathroom for vandalism, destruction of properties, and also for illegal drug activities and there are some instances that business owners were the ones liable for the death of the bathroom user resulting to the closure of their business from litigations. Employees are also in danger because some bathroom users that use drugs in the bathroom are leaving their uncapped needles resulting to many incidences of reported needle sticks that destroy the future of young and old employees because of some communicable disease associated with needle stick such as HIV AIDs and other blood-borne diseases. And Hepatitis a, b, c etc. Because of this problem Tsekmo owner created smart monetization.

Briefly stated, the present invention is directed towards online system for users to find public restrooms and private restrooms in nearby vicinity. The system allows the user to register to the application through a simple registration process and then can find the bathrooms or can register their business of bathrooms. The system also allows business owners to upload pictures of the bathroom and will give their available schedule in days hours, and minutes. They can also offer services, items for sale, and items for lease.

The business owner can start monetizing his/her bathroom by registering first at Tsekmo and then asking bathroom users to register as well in the Tsekmo app. The bathroom users have options to use the bathroom by asking for the key or asking to open the door. Once the business owner hands the key or opens the door to the customer is when the time starts and when the bathroom user handed the key or went to the counter and informed the business owner that he is done is when the time stops. For lock bathroom that uses digital. The business owner will manually put the time the bathroom user used the bathroom and charge in the Tsekmo app until the advent of smart Tsekmo locks.

The business owner has the option to monetize the bathroom per time and per minute and also, he can use this process by adding variability to time and cost of use as the time of use by the bathroom user gets longer. The Tsekmo's formula of smart monetization:

First x min=free or$0/$/min
Then next First×min=free or $0/$/min/till number of minutes or done Then next First×min=free or$0/$/min/till number of minutes or done Businesses can always add this formula in setting up smart monetization for their bathroom as shown in table 1 as a reference.

Smart monetization can be implemented by the business owner just by owning a key to their lock bathroom whether it is an insert key, a keypad pad, or a digital lock key.

As per further embodiments, the Tsekmo Feature is for businesses to have the ability to bill a customer right away that owed the business. Whether it is vandalism, destruction of property, or the customer has a monetary due from the business, the business can always exercise the bill now at his discretion.

As per further embodiments, the Tsekmo Feature Optional ID Verification. If the business owner is not comfortable with the people surrounding his business because of many incidents of vandalism, looting, destruction of properties, or any opioid-related incident business owner has the option to verify the ID of his customer that uses his bathroom he can use optional ID verification in Tsekmo app.

The invention is based on components of an exemplary environment in which the invention may be used. The online system has focused components and is based on simple to use. Further, the online web-based application allows rating the bathroom services by giving their opinion on quantitative basis through a Likert scale and also to express their ideas, suggestions and feelings through a qualitative mode by narrating their experience. The user can rate the business owner anywhere from 1 star to 5 stars. The user can also leave a short review about their interaction and experience.

The invention as per its further embodiments provides flagging system to avoid negative experiences. The yellow flag is when a business owner suspects a number of people in a number of hours' time frame where the vandal was committed. All of the people that were yellow flagged will go to the business owner community where business owners can see what type of vandalism was posted and they too can relate or find similar vandalism in which that was posted.

The community serves as a funnel in finding the vandal by looking and comparing 2 or more posts and then checking on who were the yellow flags. Once the vandal is identified then business owners will call, and notify the vandal about the charges. Transactions will be done in the Tsekmo app.

The invention as per its additional embodiments provides red flag is, where when a business owner identifies the vandal and red flags the vandal in the entire system where some business owners will also see red flag users and now has the option to be vigilant or just refused the use of the bathroom for this user. Once the user makes a payment then the red flag will go away but this will be part of the user's history.

The invention can be viewed and used from a mobile device, the personal computer, a laptop, PDA or any computing device. In order to use the web-based application the user has to be connected to the internet to provide feedback in real-time. For real-time utility needs to be connected to the internet through local area networks (“LANs”)/wide area networks (“WANs”), wireless networks or independent internet source. Further, the internet would connect the user to the online feedback application server, through the user's computing or mobile device, where applicable.

Generally, client device may include virtually any computing device capable of receiving and sending a message over a network, such as LAN/WAN or independent network, wireless network, and the like, to and from another computing device, such as server or mobile device, and the like. The set of such devices may include devices that typically connect using a wired communications medium such as personal computers, multiprocessor systems, microprocessor-based or programmable consumer electronics, network PCs, and the like. The set of such devices may also include devices that typically connect using a wireless communications medium such as cell phones, smartphones, Tablets or PDAs. Similarly, the client device may be any device that is capable of connecting using a wired or wireless communication medium such as a PDA, POCKET PC, wearable computer, and any other device that is equipped to communicate over a wired and/or wireless communication medium.

Client device may include a browser application that is configured to receive and to send web pages, web-based messages, and the like. The browser application may be configured to receive and display graphics, text, multimedia, and the like, employing virtually any web-based language, including Standard Generalized Markup Language (SMGL), HyperText Markup Language (HTML), and so forth.

Client device may also include mobile computing devices especially smartphone, which allow the user to download the application and use it on one click. The online website has a responsiveness mode for the application to function in full on the mobile computing device. Any mobile computing device can be used by the user for using the application. Such devices include portable devices such as, cellular telephones, smart phones, Personal Digital Assistants (PDAs), handheld computers, wearable computers, tablet computers, integrated devices combining one or more of the preceding devices, and the like. The application can be downloaded easily free of cost from Google Play store. The application shall be available on iOS system by Apple in future. The invention holds its novelty that allows a user to rate business owners after their interaction.

It is appreciated that additional advantages, modifications and equivalent embodiments will be apparent to those skilled in the art. Therefore, the invention, in its broader aspects, is not limited to the specific details shown and described herein. Accordingly, various modifications may be made without departing from the spirit or scope of this invention as defined by the appended claims and their equivalents.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The invention claimed is:

1. 1. An online bathroom facility finder, feedback, rating and review software application which is available through a web portal and any mobile computing device, accessible through an app; which can be downloaded and used at users' discretion for finding a nearby bathroom, rating the bathroom in their area through quantitative and qualitative method that is embedded in the application.
2. As per claim 1, the application is a unique form of system which allows individuals to fine bathrooms in nearby area, where the bathroom can be public or private business.
3. As per claim 1, the application is user friendly and is accessible through any form of computing device by connecting to internet.
4. As per claim 1, the application is a web-based software application which is hosted through a server and has its own database for storing and reporting of reviews as per user requirement. Further, the application is designed to protect the privacy through encryption and other software tools.
5. As per claim 1, the invention is a computer-implemented feedback, review and data processing system enabled through a software app comprising a database, server and of user interface for community members in different cities and states of USA. Further the it is a system compromising of a team of admin to ensure smooth and fair reviews in line with the given guidelines and privacy policy.

2. An online system where the business owners can use the flagging system where:
As per claim 2, the yellow flag is when a business owner suspects a number of people in a number of hours' time frame where the vandal was committed.
As per claim 2, the yellow flag can be seen by business owners and can see what type of vandalism were posted and they too can relate or find the similar vandalism in which that was posted;
As per claim 2, once the vandal is identified business owners will call, notify the vandal about the charges;
As per claim 2, the transactions will be done in the Tsekmo app;
As per claim 2, the red flag is when a business owner identifies the vandal and red flags the vandal in the entire system where some business owners will also see red flag users; and,
As per claim 2, the red flag will be converted to clear flag once the user clears the payment.

3. A system to provide the option to the business owner to make it impossible for the bathroom user to use the bathroom for illegal drug activities or be penalized hard as a consequences of staying longer inside the bathroom beyond the necessary time to stay.
This is to monetize the bathroom per time and per minute and also, he/she can use this process by adding variability to time and cost of use as the time of use by the bathroom user gets longer wherein:
As per claim 3, Tsekmo's formula of smart monetization for the first minute is: First×min=free or$0/$/min;
As per claim 3, Tsekmo's formula of smart monetization for the next First×min=free or $0/$/min/till number of minutes or done;
As per claim 3, Tsekmo's formula of smart monetization for the next First×min=free or$0/$/min/till number of minutes or done;
As per claim 3, businesses can always add this formula in setting up smart monetization for their bathroom as shown in table 1 as a reference.

4. As per claim 3, a system of providing optional ID Verification wherein, If the business owner is not comfortable with the people surrounding his business because of many incidents of vandalism, looting, destruction of properties, or any opioid-related incident business owner has the option to verify the ID of his customer that uses his bathroom he can use optional ID verification in Tsekmo application to accurately identify, red flag and report the vandals.

5. As per claim 3, a bill now option is provided through the Tsekmo application allowing businesses the ability to bill a vandal right away that owed the business.
